(19) United States
(12) Patent Application Publication
(10) Pub. No.: US 2025/0217667 A1
(43) Pub. Date: Jul. 3, 2025

(54) METHOD, ELECTRONIC DEVICE, AND COMPUTER PROGRAM PRODUCT FOR QUESTION ANSWERING SYSTEM

(71) Applicant: Dell Products L.P., Round Rock, TX (US)

(72) Inventors: Zijia Wang, Weifang (CN); Bin He, Shanghai (CN); Chunxi Chen, Shanghai (CN); Zhen Jia, Shanghai (CN)

(21) Appl. No.: 18/419,754

(22) Filed: Jan. 23, 2024

(30) Foreign Application Priority Data
Dec. 27, 2023 (CN) 202311823471.8

(51) Int. Cl. G06N 5/02; G06F 40/35

(52) U.S. Cl. CPC G06N 5/02; G06F 40/35

(57) ABSTRACT

A method in an illustrative embodiment includes determining, based on a question input by a user to a question answering system, a root node associated with the question in a decision tree of the question answering system that is used for generating an answer to a question; determining, based on the root node, a plurality of candidate child nodes among a plurality of child nodes of the root node; determining, based on a plurality of similarities of a plurality of candidate paths between the root node and the plurality of candidate child nodes, a target path among the plurality of candidate paths; generating an answer to the question based on the target path; and determining, based on a reply of the user to the answer, a label for the reply from the user, wherein the label includes a classification of the question and a degree of satisfaction with the answer.

### RELATED APPLICATION

The present application claims priority to Chinese Patent Application No. 202311823471.8, filed Dec. 27, 2023, and entitled “Method, Electronic Device, and Computer Program Product for Question Answering System,” which is incorporated by reference herein in its entirety.

### FIELD

Embodiments of the present disclosure relate to the field of computers, and more specifically, to a method, an electronic device, and a computer program product for a question answering system.

### BACKGROUND

A question answering system is an advanced form of an information retrieval system, which can answer, in an accurate and concise natural language, a question proposed by a user in a natural language. A main reason for the rise of its research is user demand for fast and accurate information acquisition. The question answering system may be classified into two categories: rule-based and machine learning-based. A working principle of the question answering system usually includes the following steps: language understanding, information retrieval, answer extraction, and answer ranking and generation.

Application fields of the question answering system include online customer service, education, medical health, internal knowledge sharing of enterprises, legal service, and the like. The question answering system faces some challenges, such as the accuracy of semantic understanding, the efficiency of information retrieval, and the naturalness of answer generation.

### SUMMARY

Embodiments of the present disclosure provide a method, an electronic device, and a computer program product for a question answering system.

According to a first aspect of the present disclosure, a method for a question answering system is provided. The method includes determining, based on a question input by a user to the question answering system, a root node associated with the question in a decision tree of the question answering system that is used for generating an answer to the question. The method further includes determining, based on the root node, a plurality of candidate child nodes among a plurality of child nodes of the root node, wherein a plurality of similarities between the plurality of candidate child nodes and the question are greater than a threshold. The method further includes determining, based on a plurality of similarities of a plurality of candidate paths between the root node and the plurality of candidate child nodes, a target path among the plurality of candidate paths. The method further includes generating an answer to the question based on the target path. The method further includes determining, based on a reply of the user to the answer, a label for the reply from the user, wherein the label includes a classification of the question and a degree of satisfaction with the answer.

According to a second aspect of the present disclosure, an electronic device is further provided. The electronic device includes a processor and a memory coupled to the processor, wherein the memory has instructions stored therein, and the instructions, when executed by the processor, cause the device to perform actions. The actions include determining, based on a question input by a user to the question answering system, a root node associated with the question in a decision tree of the question answering system that is used for generating an answer to the question. The actions further include determining, based on the root node, a plurality of candidate child nodes among a plurality of child nodes of the root node, wherein a plurality of similarities between the plurality of candidate child nodes and the question are greater than a threshold. The actions further include determining, based on a plurality of similarities of a plurality of candidate paths between the root node and the plurality of candidate child nodes, a target path among the plurality of candidate paths. The actions further include generating an answer to the question based on the target path. The actions further include determining, based on a reply of the user to the answer, a label for the reply from the user, wherein the label includes a classification of the question and a degree of satisfaction with the answer.

According to a third aspect of the present disclosure, a computer program product is provided. The computer program product is tangibly stored on a non-transitory computer-readable medium and includes computer-executable instructions, wherein the computer-executable instructions, when executed by a device, cause the device to perform the method according to the first aspect.

This Summary is provided to introduce the selection of concepts in a simplified form, which will be further described in the Detailed Description below. The Summary is neither intended to identify key features or principal features of the claimed subject matter, nor intended to limit the scope of the claimed subject matter.

### BRIEF DESCRIPTION OF THE DRAWINGS

The above and other features, advantages, and aspects of embodiments of the present disclosure will become more apparent in conjunction with the accompanying drawings and with reference to the following Detailed Description. In the accompanying drawings, identical or similar reference numerals represent identical or similar elements, in which:

FIG. 1 is a schematic diagram of an example environment in which embodiments of the present disclosure can be implemented;

FIG. 2A is a schematic diagram of an overall process for a question answering system according to an example implementation of the present disclosure;

FIG. 2B is a schematic diagram of a decision tree according to an example implementation of the present disclosure;

FIG. 3 is a flow chart of a method for a question answering system according to an example implementation of the present disclosure;

FIG. 4 is a block diagram illustrating reinforcement learning for path selection according to an example implementation of the present disclosure;

FIG. 5 is a block diagram illustrating details of a reply processing module according to an example implementation of the present disclosure;

FIG. 6 is a block diagram illustrating details of a dialog state tracking module according to an example implementation of the present disclosure;

FIG. 7 is a block diagram illustrating details of a dialog memory network module according to an example implementation of the present disclosure; and

FIG. 8 is a block diagram of a device for a question answering system according to an example implementation of the present disclosure.

In all the accompanying drawings, identical or similar reference numerals indicate identical or similar elements.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below. In addition, all specific numerical values herein are examples, which are provided only to aid in understanding, and are not intended to limit the scope.

As discussed in the above background, a question answering system needs to be improved in terms of accuracy of semantic understanding, efficiency of information retrieval, naturalness of answer generation, and the like. Decision tree navigation is a well-researched issue in machine learning and artificial intelligence, with many applications in various fields such as user service, robot navigation, and medical diagnosis.

One method of the decision tree navigation is a C4.5 algorithm, which is an extension of an ID3 algorithm. The C4.5 algorithm uses information gain as a splitting criterion and can handle both continuous and discrete attributes, missing values, and branch pruning. However, the C4.5 algorithm has some drawbacks, such as sensitivity to noise and outliers, generating large and complex trees, and requiring a lot of computational resources.

Another method of the decision tree navigation is a CART algorithm, which stands for classification and regression trees. The CART algorithm uses a Gini index as a splitting standard and can deal with classification and regression issues simultaneously. The CART algorithm further performs branch pruning to avoid overfitting, and can process missing values by proxy splitting. However, the CART algorithm also has some limitations, such as tending to have variables with more levels, generating only binary trees, and being computationally expensive.

Still another method of the decision tree navigation is a decision flow algorithm, which combines a classical decision tree learning method with statistic-based merging of nodes from the same and/or different levels. The decision flow algorithm uses two sample test statistical magnitudes to measure a similarity between nodes and merges them if they are similar enough. In this way, the design of the decision flow algorithm avoids overfitting, reduces the model complexity, and improves the prediction accuracy. However, the decision flow algorithm also requires a lot of memory to store the similarity matrix, and some information may be lost in the merging process.

Decision tree navigation is a method in machine learning and artificial intelligence that has many applications in various fields such as user service, robot navigation, and medical diagnosis. However, while decision tree navigation is popular and useful, it also faces some challenges that limit its performance and applicability. These challenges include data fragmentation, that is, as the size and depth of the decision tree grow, data points in leaf nodes become increasingly fewer, leading to data depletion and overfitting. This problem can be alleviated by pruning the tree or using an integrated approach, but these techniques have their own drawbacks, such as loss of information or increased complexity.

Another example is in data quality, data presentation, and user interaction. The data quality means that the quality of data used for building and navigating a decision tree may affect the accuracy and robustness of a model. For example, noise, outliers, missing values, and unrelated features may reduce information gain and introduce errors into splitting criteria. The data representation means that the feature and label representation of the data may also affect the performance of the decision tree navigation. For example, continuous and discrete attributes may require different splitting methods, classification values may need to be encoded or transformed, and unbalanced categories may lead to classification bias. The user interaction means that the interaction between a user and a decision tree navigation system may also bring some challenges to the model. These include, for example, how to process a natural language input of a user, how to generate a human-like question for a user, how to process and understand an answer of a user, how to maintain context and coherence of a dialog, how to provide personalization and personalized services, and how to ask a relevant question based on information and preferences of a user.

In order to address the above defects, embodiments of the present disclosure provide a solution for a question answering system. The solution of the present invention provides a method for navigating a complex decision tree based on a user input and a dialog memory, which can help improve user service, solve a problem efficiently, and increase user satisfaction. For example, in embodiments disclosed herein, a method for decision tree navigation based on natural language processing and reinforcement learning techniques is provided, which differs from traditional methods in several respects: (1) the natural language processing technique is used to preprocess the user input and extract a feature from it; (2) a question-sensitive text similarity measure is used for matching the user input with the most relevant node in the decision tree; (3) the reinforcement learning is used to generate an optimal path from the root node to a child node; (4) it uses a text-to-text converter to pose a human-like question to the user; (5) it uses a generative pre-trained transformer and a traditional natural language processing method to process an answer of the user; (6) a dialog state tracking module is used to track the information and preferences of the user throughout the dialog; and (7) it uses a conversational memory network to provide a more personalized and context-sensitive question.

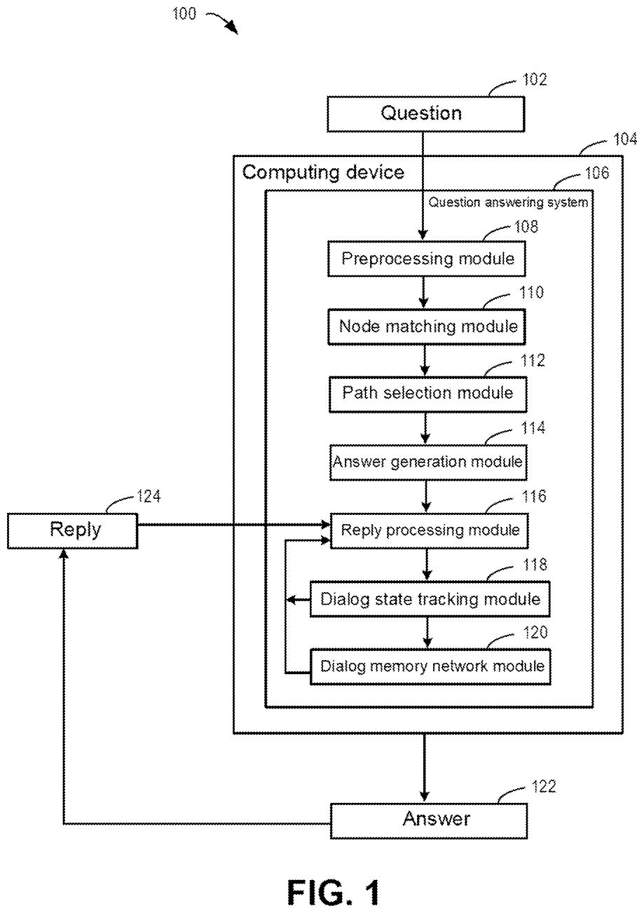

FIG. 1 is a schematic diagram of an example environment 100 in which embodiments of the present disclosure can be implemented. As shown in FIG. 1, the example environment 100 may include a computing device 104. The computing device 104 may be, for example, a computing system or a server. A question answering system 106 may be installed on the computing device 104. An example of the question answering system 106 may be a customer service system, a fault diagnosis system, or the like. The computing device 104 receives an input from the user, which is a question 102. It is understood that the question 102 includes not only an interrogative sentence, but also a declarative description of the problem encountered by the user, and the like. The question 102 may include, for example, “My computer can't be charged,” “How can I keep my computer battery from overheating?” and the like.

After receiving the question 102, a preprocessing module 108 in the question answering system 106 may extract semantic information of the question 102 and transform the semantic information into a feature vector. The feature vector may be used by a node matching module 110 to match a root node with the highest semantical similarity to the question 102 and some child nodes of the matched root node in the decision tree. A path selection module 112 may find a target path with the highest similarity among a plurality of candidate paths according to similarities between respective feature vectors of the matched root node and these child nodes and the feature vector of the question 102. In other words, on the target path, a plurality of nodes may be included on the path from the root node to the child node, and the sum of similarities between adjacent nodes is the greatest.

After the target path is selected, an answer generation module 114 generates an answer 122 to the question 102 based on the feature vectors of the individual nodes on the target path, and possibly also on the dialog state and information in a dialog memory. An example of the answer 122 may be “Is your computer under warranty?” or “Is your computer plugged in now?” or the like.

After receiving the answer 122, the user may continue to give a reply 124 to the answer 122. An example of the reply 124 may be “yes,” “I don't know,” and the like. After the question answering system 106 receives the reply 124, a reply processing module 116 may determine the degree of satisfaction of the user with the current conversation, label the current conversation, and the like. Based on the label, a dialog state tracking module 118 and a dialog memory network module 120 may keep the context of the dialog up to date, thereby being conducive to the accuracy of the generated answer and improving the efficiency. The dialog state tracking module 118 may be used for tracking the information and preferences of the user throughout the dialog and using the dialog memory network to provide a more personalized and context-sensitive question.

In summary, the preprocessing module 108 may treat the user input as a natural language text and perform some preprocessing steps such as labelization, lemmatization, and stop word removal. It also uses a pre-trained language model, such as BERT or ROBERTa, to extract features from the text and produce high-quality embeddings.

The node matching module 110 may take features from the preprocessing module 108 and compare them with the features of the nodes in the decision tree. It uses the question-sensitive text similarity measure (such as S-BERT) to calculate similarity scores between the user input and node labels. It then selects the most relevant node that matches the user input.

The path selection module 112 may take the selected nodes from the node matching module 110 and generate the optimal path from the root node to the child node. It uses the reinforcement learning method, such as Q-learning, to learn a strategy that maximizes the total similarity score while respecting the dependencies between nodes. It also updates a Q value based on a reward and a punishment it receives from user feedback.

The answer generation module 114 may take selected nodes and the optimal path to formulate a human-understandable and human-like question for the user. It uses the text-to-text converters (such as T5) to generate a user-relevant and informative natural language question.

The reply processing module 116 may take the answer of the user as the natural language text and process it to extract key information and understand the context of the answer. It uses a combination of the generative pre-trained transformer and the traditional natural language processing method (such as named entity recognition) to perform tasks such as answer validation, answer extraction, and answer classification.

The dialog state tracking module 118 may track the information and preferences of the user throughout the dialog. It uses a dialog state tracking model, such as DSTC2, to maintain a dialog state vector that represents a current state of the dialog. The dialog memory network module 120 may maintain the memory of key entities and concepts extracted from user responses. It uses a conversational memory network model, such as CMN, to store and retrieve relevant information from memory based on the current dialog state. These modules 108 to 120 work together to provide an efficient and effective solution for the decision tree navigation and improved user experience.

It should be understood that the architecture and functions in the example environment 100 are described only for example purposes, without implying any limitation to the scope of the present disclosure. Embodiments of the present disclosure may also be applied to other environments having different structures and/or functions.

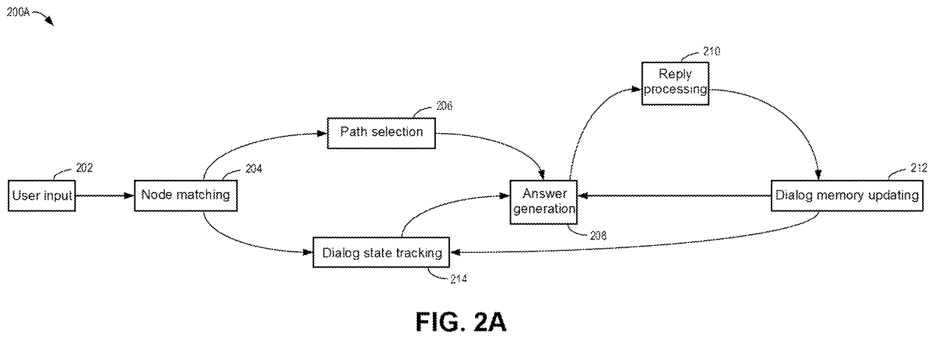

FIG. 2A is a schematic diagram of an overall process 200A for a question answering system according to an example implementation of the present disclosure. FIG. 2A shows the main steps of a decision tree navigation method based on a user input 202 and a dialog memory. In the overall process 200A, the user input 202 is matched in a node matching module 204 to the most relevant node in the decision tree, an optimal path from a root node to a child node is selected in a path selection module 206, a human-understandable question is generated in an answer generation module 208 for the user, an answer or other reply of the user is processed in a reply processing module 210, and the dialog memory is updated in a dialog memory updating module 212 by using key entities and concepts. The overall process 200A further tracks a dialog state in a dialog state tracking module 214 to maintain the context of the dialog. The overall process 200A repeats these steps until the child node is reached or the user terminates the dialog.

Specifically, the user input 202 is entered into the node matching module 204. In the node matching module 204, the question-sensitive text similarity measure is used to match the user input 202 with the most relevant node in the decision tree. In the path selection module 206, the reinforcement learning method is used to generate the optimal path from the root node to the leaf node (also known as the child node). In the answer generation module 208, the text-to-text converter is used to pose a human-understandable question to the user. In the reply processing module 210, the generative pre-trained transformer and the traditional natural language processing method are used to update the dialog memory in the dialog memory updating module 212 with key entities and concepts extracted from user responses.

In the overall process 200A, applying the question-sensitive text similarity measure to perform node matching can solve some shortcomings of existing measures that rely on n-gram overlap scores. Path selection is combined with the reinforcement learning method, which can help the model learn from its own behaviors and rewards, and optimize its strategy to maximize the total similarity score while respecting dependencies between nodes. The combination of the conversational memory network may retain the memory of key entities and concepts extracted from the answer of the user and use the memory to provide a more personalized and context-sensitive question.

FIG. 2B is a schematic diagram of a decision tree 200B according to an example implementation of the present disclosure. As shown in FIG. 2, the decision tree 200B includes a root node 220. The root node may be understood as a preliminary classification of the question. For example, the root node may be a “question about memory.” The root node 220 may also include a child node 222, a child node 224, a child node 226, a child node 228, and a child node 230. The child nodes may be some more subdivided questions. For example, a “question about a single memory” or a “question about a BIOS version.” There is a logical relationship, or connection relationship, between these child nodes. These logical relationships or connection relationships form paths. For example, a path from the root node 220 to the child node 230 may go through a path 240 and a path 250, or through a path 242 and a path 248. Additional paths shown in the figure include a path 244 and a path 246. Some or all of these combinations of different paths may be selected as candidate paths, depending on how similar the different paths are to a threshold.

This combination of paths from the root node to the child node may have different similarities. For example, if the path 240 and the path 250 have similarities of 0.5 and 0.6, the total similarity from the root node 220 to the child node 230 via the path 240 and the path 250 may be 0.5+0.6=1.1. For another example, if the path 242 and the path 248 have similarities of 0.7 and 0.8, the total similarity from the root node 220 to the child node 230 via the path 242 and the path 248 may be 0.7+0.8=1.5. If the threshold is set to 1, both paths may be selected as candidate paths.

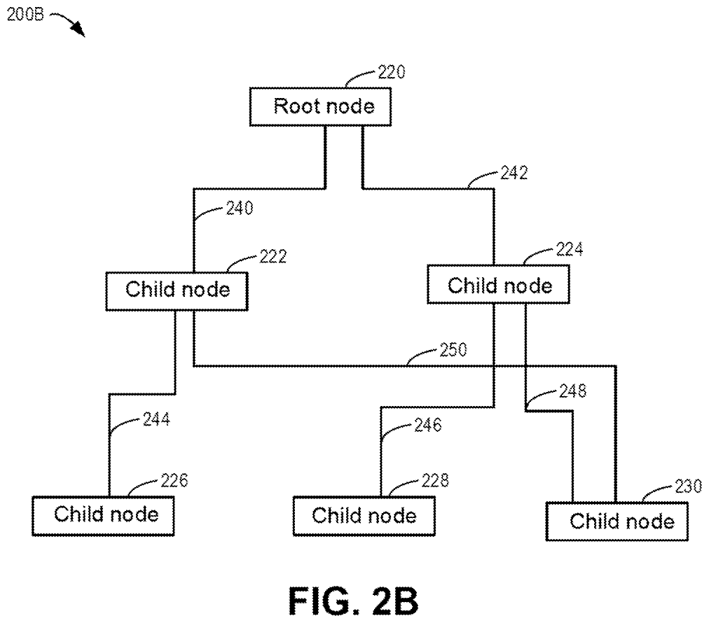

A process according to an embodiment of the present disclosure will be described in detail below with reference to FIG. 3 to FIG. 7. For ease of understanding, the specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 3 is a flow chart of a method 300 for a question answering system according to an example implementation of the present disclosure. At block 302, it is determined, based on a question input by a user to a question answering system, a root node associated with the question in a decision tree of the question answering system that is used for generating an answer to a question. For example, if the question is “Why is my computer so slow?” The root node may be a “memory failure.” The root node may be understood as a preliminary classification of the question.

In some embodiments, the block 302 may be performed in a preprocessing module based on a natural language model. The preprocessing module treats the user input as a natural language text and performs some preprocessing steps, such as labelization, lemmatization, and stop word removal. These steps are common in natural language processing tasks and aim to normalize and simplify text to further normalize and simplify the text for candidate processing. For example, if the user inputs “I have a problem with my laptop battery,” the preprocessing module may output the following labels: [“problem,” “laptop,” “battery”].

The preprocessing module further uses a pre-trained language model, such as BERT or ROBERTa, to extract features from the text and generate high-quality embeddings. These embeddings are dense vector representations of the text, and its semantic and syntactic information is captured. The pre-trained language model is trained on a large text corpus by using a self-supervised learning objective, such as mask language modeling and next sentence prediction. These objectives enable the model to learn general language understanding skills, and these skills may be transferred to a variety of downstream tasks. For example, if the user inputs “I have a problem with my laptop battery,” the preprocessing module may output the following embedding: [0.23, −0.12, 0.45, . . . , −0.34] (assuming that there are 768 dimensions in an embedding space). The output of the preprocessing module is then further processed by an input node matching module.

At block 304, it is determined, based on the root node, a plurality of candidate child nodes among a plurality of child nodes of the root node, wherein a plurality of similarities between the plurality of candidate child nodes and the question are greater than a threshold. For example, the block 304 is performed in the node matching module. The node matching module acquires features from the preprocessing module and compares them with the features of the nodes in the decision tree. Instead of matching them directly to the nodes, it uses the question-sensitive text similarity measure (such as S-BERT) to calculate the user input and node labels. The question-sensitive text similarity measure is a variant of BERT that fine-tunes a large dataset of question pairs with similarity labels. The fine-tuning enables the model to learn how to encode a question in a way that preserves semantic similarities and differences. For example, it is given that the user enters “I have a problem with my laptop battery” and a node label “Is your laptop plugged in?” The node matching module may output a similarity score of 0.67 (assuming a range from 0 to 1).

The node matching module then selects the most relevant node that matches the user input based on the similarity score. The selection criteria may be a threshold or a sorting method. For example, suppose that the user inputs “I have a problem with my laptop battery” and three node labels: “Is your laptop plugged in?” “Is your laptop overheating?” and “Is your laptop under warranty?” The node matching module may select the first node as the most relevant based on its similarity score of 0.67 (assuming a threshold of 0.5 or a ranking method that selects the highest score). The output of the node matching module is then fed to the path selection module for further processing.

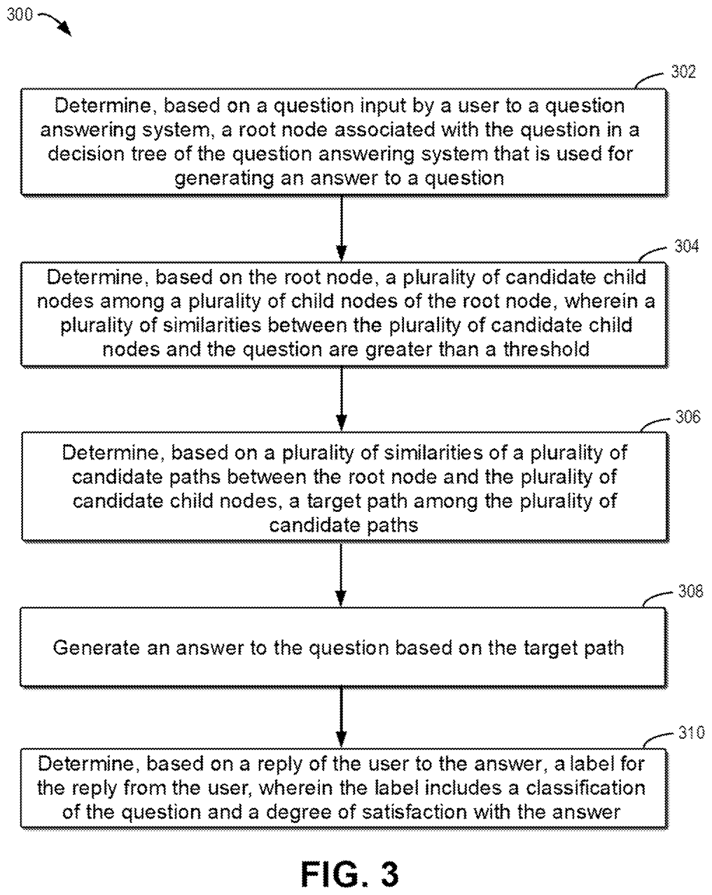

At block 306, it is determined, based on a plurality of similarities of a plurality of candidate paths between the root node and the plurality of candidate child nodes, a target path among the plurality of candidate paths. The implementation of the path selection module is described below with reference to FIG. 4.

As shown generally at 400 in FIG. 4, user input 402 is subject to node matching 404 to determine a current node 406. In some embodiments, the path selection module acquires the selected node from the node matching module and generates the optimal path from the root node to the child node. It uses a reinforcement learning method (such as Q learning) to learn strategies that maximize the total similarity score while respecting the dependencies between nodes. The path selection module performs Q learning 408 using reinforcement learning module 420 which includes components for action selection 410, reward calculation 412, Q value updating 414 and determination of optimized path 416.

The reinforcement learning is a type of machine learning that learns from its own behaviors and rewards without the need of explicit supervision or label. The Q learning method is a model-free algorithm for learning a Q function, the Q function is a table that maps each state-action pair to a Q value, and the Q value is an estimate of expected future rewards. The Q learning algorithm updates Q values according to the following update rule (1):

$$Q ( s , a ) ← Q ( s , a ) + α [ r + γ {max}_{{a}^{′}} Q ( {s}^{′} , {a}^{′} ) - Q ( s , a ) ] \qquad ( 1 )$$

wherein s represents the current state, a represents the current action, s′ represents the next state, a′ represents the next action, r represents the immediate reward, α represents the learning rate, and γ represents the discount factor.

As an example, the state may be the current node in the decision tree, the operation may be the next node to move to, the reward may be the similarity score between the user input and the node label, and the Q value may be the expected total similarity score along the path. The path selection module explores the strategy by using an epsilon-greedy (ε-greedy) algorithm, which means that it selects a random action with a probability & and selects an action having the highest Q value with a probability 1−ε. The strategy balances exploration and utilization and ensures that the module is able to discover a new path and improve its strategy over time.

Then, the path selection module outputs the optimal path from the root node to the child node according to its learned strategy. The optimal path is a path that maximizes the total similarity score while respecting the dependencies between the nodes. For example, suppose that the user inputs “I have a problem with my laptop battery” and the decision tree includes four nodes: “Is your laptop plugged into the power source?” “Is your laptop overheating?” “Is your laptop under warranty?” and “Contact customer service,” and the path selection module may output the following optimal path: [“Is your laptop plugged into the power source?” “Is your laptop overheating?” and “Contact customer service”] (assuming a total similarity score of 1.8). The output of the path selection module is then fed to a question generation module for further processing.

Now returning to FIG. 3, at block 308, an answer to the question is generated based on the target path. For example, the question generation module acquires the selected node and the optimal path from the previous module and formulates a human-like question for the user. It uses the text-to-text converters (such as T5) to generate a user-relevant and informative natural language question. The text-to-text converter is a neural network model that may perform a variety of natural language processing tasks by using a unified text-to-text framework. The model is pre-trained on a large text corpus by using a self-supervised target (such as span corruption) and then fine-tunes a specific task by using supervision data. The model may generate a high-quality text output given some text inputs and task prefixes.

As an example, assume the text input is the selected node and the optimal path, and the task prefix is “Generate question.” The question generation module then uses the text-to-text converter to generate a natural language question that corresponds to the selected node and the optimal path. For example, given the selected node “Is your laptop plugged in?” and the optimal path [“Is your laptop plugged into the power source?” “Is your laptop overheating?” and “Contact customer service”], the question generation module may output the following question: “To help you solve your laptop battery problem, please answer this question: Is your laptop plugged into the power source?” The output of the question generation module is then presented to the user to answer. The answer of the user is then input to the answer processing module for further processing.

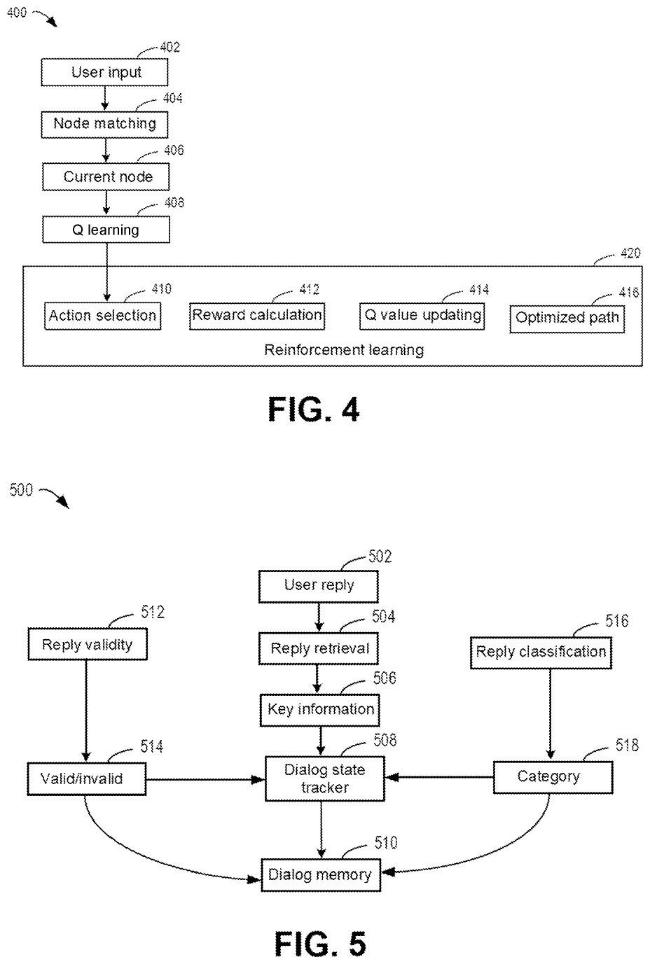

At block 310, it is determined, based on a reply of the user to the answer, a label for the reply from the user, wherein the label includes a classification of the question and a degree of satisfaction with the answer. For example, the step is performed in a reply processing module. The reply processing module is described below with reference to FIG. 5. FIG. 5 is a block diagram illustrating details of the reply processing module 500 according to an example implementation of the present disclosure. The reply processing module 500 treats the answer of the user (also known as a reply 502) as a natural language text, and processes it to extract key information and understand the context of the answer. It uses a combination of the generative pre-trained transformer and the traditional natural language processing method (such as named entity recognition) to perform tasks such as reply validation, reply retrieval, and reply classification. A reply validity 512 task for reply verification is to check the validity 514 of the reply 502 of the user and is consistent with the question. For example, if the question is “Is your laptop plugged into the power source?,” a valid reply is “yes” or “no,” and any other answer is invalid. A reply retrieval 504 task is to extract key information 506, such as entities, concepts, and values, from the reply 502 of the user. For example, if the question is “What is your laptop model?,” the reply extraction task is to extract the model name from the answer of the user, such as “Model B of brand A.” The reply classification 516 task is to categorize the answer of the user into a pre-defined category 518 or label, such as positive, negative, and neutral. For example, if the question is “Are you satisfied with our service?,” the answer classification task may be classifying the answer of the user into one of these categories, such as “Very satisfied,” “Satisfied,” “Average,” “Dissatisfied,” or “Very dissatisfied.”

Given some text input and task prefixes, the reply processing module 500 generates a natural language output for each task by using a generative pre-trained transformer. For example, given the reply of the user “yes” and the task prefix “reply validation:,” the reply processing module 500 may output “valid.” Similarly, given the reply of the user “Model B of brand A” and the task prefix “reply extraction:,” the reply processing module 500 may output “Model: Model B of brand A.” Given the answer of the user “I am very satisfied with your service” and the task prefix “Reply category:,” the reply processing module 500 may output “very satisfied.”

The reply processing module 500 further uses the traditional natural language processing method to complement the generative pre-trained transformer, especially when processing structured or numerical data. For example, if the question is “How long? Have you been using your laptop all along?,” the reply processing module 500 may use the named entity recognition method to recognize and extract a duration in the answer of the user, such as “3 years.” The output of the reply processing module 500 is then fed to a dialog state tracking module 508 and a dialog memory network module 510 for further processing.

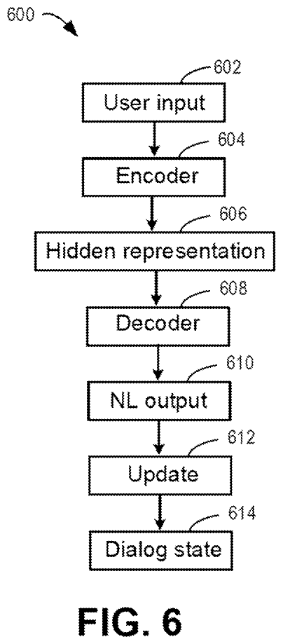

In some embodiments, the method 300 may also determine, based on the validity, key information, and classification, a dialog state indicating the user information and the behavioral preferences of the user to serve as the label. In some embodiments, the method 300 may also determine the dialog state based on the label, the question, the answer, a history label, a history question, and a history answer; and update a historical dialog state by utilizing the dialog state. For example, the step is performed in the dialog state tracking module. The dialog state tracking module is described below with reference to FIG. 6.

As shown in FIG. 6, the dialog state tracking module 600 tracks the information and preferences of the user throughout the dialog. The dialog state tracking module 600 uses a dialog state tracking model (such as DSTC2) to maintain a dialog state vector that represents a current state of the dialog. The dialog state vector is a structured representation of information relevant to the decision tree navigation, such as a question of the user, a solution, and a feedback. The dialog state tracking module 600 updates the dialog state vector, the output of the system, and the context of the dialog based on the input of the user.

The dialog state tracking module 600 uses a neural network model consisting of three components: an encoder 604, a decoder 608, and an updater 612. The encoder 604 uses a recurrent neural network (RNN) to encode a user input 602 and a system output as a hidden representation 606. The decoder 608 uses another RNN to decode the hidden representation into a natural language output 610. The updater 612 uses a rule-based or learning-based method to update a dialog state vector 614 based on the natural language output 610 and a dialog context.

The dialog state tracking module 600 helps track the information and preferences of the user throughout the dialog and provides continuity and coherence to the dialog. For example, if a customer says “I have a problem with my laptop battery,” the dialog state tracking module 600 may update the dialog state vector with the following information: {Question: Problem with the laptop battery}. If the system asks “Is your laptop plugged into the power source?” and if the user says “yes,” the dialog state tracking module may update the dialog state vector with the following information: {Question: Problem with the laptop battery, Solution: The laptop is plugged in}. The output of the dialog state tracking module is then fed to the answer generation module and the conversational memory network module for further processing.

In some embodiments, the method 300 may further retrieve, based on the dialog state, information associated with the dialog state; and determine, based on the retrieved information, a structured representation of the current conversation, wherein the structured representation includes a plurality of entities and a plurality of corresponding concepts; and store the structured representation in a memory. For example, the step may be performed in the conversational memory network module.

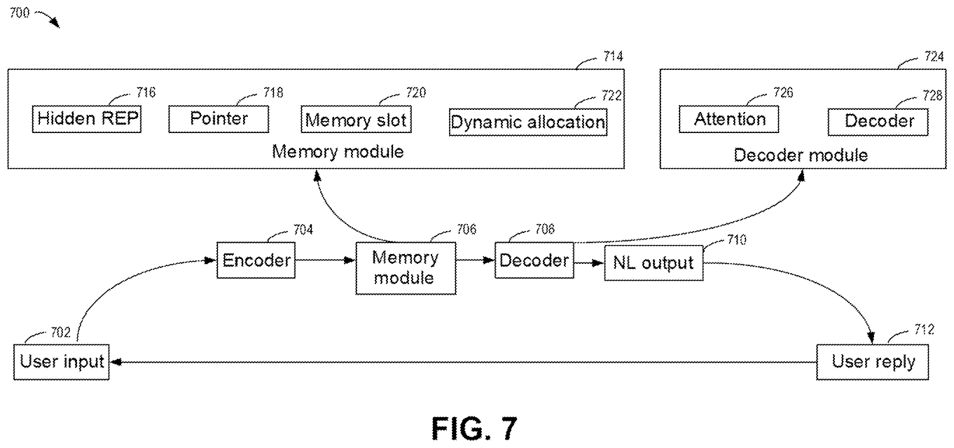

The conversational memory network module maintains the memory of key entities and concepts extracted from user responses. It uses a conversational memory network (CMN) model to store and retrieve relevant information from memory based on the current dialog state. The conversational memory network model is a neural network model that generally comprises four parts: an encoder, a memory, an attention mechanism, and a decoder. The encoder uses a recurrent neural network (RNN) to encode the response of the user into a hidden representation. An example conversational memory network module 700 is described in more detail below with reference to FIG. 7.

As illustrated in FIG. 7, the memory in conversational memory network module 700 uses a dynamic memory allocation mechanism 722 to store the hidden representation as a memory slot 720. The attention mechanism 726 and the decoder 728 in the decoder module 724 use a dot product operation to calculate an attention weight between the memory slot and the current dialog state vector. To speed up retrieval from the memory, data may be stored by using a hidden REP 716 and a pointer 718. The decoder uses another RNN to decode a weighted sum of the memory slot into a natural language output.

Also as shown in FIG. 7, the conversational memory network module 700 helps maintain a memory of key entities and concepts extracted from a user input 702 and uses the memory to provide a more personalized and context-sensitive question. For example, if a customer says “I bought this laptop from Amazon last month,” the conversational memory network module may store the following information in a memory via an encoder 704 and a memory module 706: {Entity: Laptop, Concept: Date of purchase, Value: Last month}, {Entity: Laptop, Concept: Date of purchase, Value: Last month}, {Entity: Laptop, Concept: Date of purchase, Value: Last month}: Laptop, Concept: Source of purchase, Value: Amazon}. If the system asks “Is your laptop under warranty?,” and when the customer says “I don't know,” the conversational memory network module 700 may retrieve the following information from the memory module 714: {Entity: Laptop, Concept: Date of purchase, Value: Last month}, {Entity: Laptop, Concept: Source of purchase, Value: Amazon}. It may then generate the following reply 712 via the decoder 708 and the natural language output 710: “Does the laptop you purchased from Amazon come with an extended warranty?” The output of the conversational memory network module is then presented to the user to answer. The answer of the user is then input to the answer processing module for further processing.

In summary, FIG. 7 shows the data flow and components of the conversational memory network module 700. The user response is encoded by the encoder 704 and stored in the memory. The hidden representation is stored as a memory slot 720 by using a pointer that tracks the next available memory slot. The dynamic memory allocation method allocates or releases memory slots as needed. The attention mechanism calculates the attention weight between the memory slot and the current dialog state vector. The decoder 728 decodes the weight sum of the memory slot into a natural language output. The natural language output is presented to the user to answer. The reply of the user is then fed back into the module to update the memory and generate the next output.

The method of the present disclosure uses the conversational memory network module to store and retrieve relevant information into and from the memory based on the current dialog state, whereas the traditional method uses a simple memory mechanism to store the response of the user as a list of key-value pairs. The method of the present disclosure uses the dynamic memory allocation mechanism to allocate or release memory slots as needed, whereas the traditional method uses a fixed memory size, which may waste or deplete memory space.

The method of the present disclosure uses an episodic memory module to extract the context of influences between self and a speaker and synthesize them to update memory, whereas the traditional method does not consider influences between self and a speaker in the process of memory updating. The method of the present disclosure may provide the user with a more personalized and context-sensitive question because it may retrieve relevant information from the memory based on the current dialog state and use the information to generate a natural language output. This can improve the user experience and a degree of satisfaction, as well as the accuracy and efficiency of decision tree navigation.

The method of the present disclosure may save memory space and avoid memory leaks because it can allocate or release memory slots as needed and only store information related to the decision tree navigation. This can improve scalability and robustness, and reduce the computational cost and complexity. The method of the present disclosure may capture the influences between self and a speaker during the memory updating because it can extract the context of the influences between self and a speaker and synthesize them for memory updating. This can improve the coherence and continuity of the dialog, as well as the consistency and reliability of the decision tree navigation.

The method of the present disclosure can help enterprises provide better user services and support because it can guide users to complete complex decision trees by using natural language processing and reinforcement learning technologies. This can help enterprises solve questions of users faster and more efficiently, and improve the user loyalty and retention. The method of the present disclosure may help enterprises improve their products and services because it may collect valuable feedback and data from users by using the natural language processing and reinforcement learning technologies. This can help enterprises better understand requirements and preferences of users and recognize potential questions and opportunities for improvement.

In conclusion, in the present disclosure, a method for decision tree navigation based on natural language processing and reinforcement learning technologies is provided. The method of the present disclosure extends a traditional decision tree to a more general and powerful directed acyclic graph and constructs a decision graph by recursively growing the decision tree internally or within a child node. In some embodiments, the method of the present disclosure further uses the conversational memory network module to store and retrieve relevant information into and from the memory according to the current dialog state, and uses the dynamic memory allocation mechanism to allocate or release memory slots as needed. The method of the present disclosure further uses the episodic memory module to extract the context of the influences between self and a speaker and synthesize them to update memory.

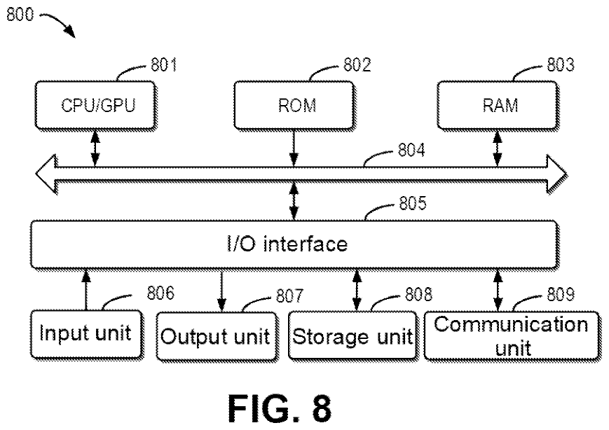

FIG. 8 illustrates a block diagram of a device 800 that may be used to implement embodiments of the present disclosure. The device 800 may be the device or apparatus described in embodiments of the present disclosure. As shown in FIG. 8, the device 800 includes a Central Processing Unit and/or a Graphics Processing Unit (CPU/GPU) 801, which may execute various appropriate actions and processing in accordance with computer program instructions stored in a Read-Only Memory (ROM) 802 or computer program instructions loaded onto a Random Access Memory (RAM) 803 from a storage unit 808. In the RAM 803, various programs and data required for the operation of the device 800 may also be stored. The CPU/GPU 801, the ROM 802, and the RAM 803 are connected to one another through a bus 804. An input/output (I/O) interface 805 is also connected to the bus 804. Although not shown in FIG. 8, the device 800 may also include a co-processor.

A plurality of parts in the device 800 are connected to the I/O interface 805, including: an input unit 806, such as a keyboard and a mouse; an output unit 807, such as various types of displays and speakers; a storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The various methods or processes described above may be performed by the CPU/GPU 801. For example, in some embodiments, the method may be embodied as a computer software program that is tangibly included in a machine-readable medium, such as the storage unit 808. In some embodiments, some or all of the computer program may be loaded and/or installed onto the device 800 via the ROM 802 and/or the communication unit 809. When the computer program is loaded into the RAM 803 and executed by the CPU/GPU 801, one or more steps or actions of the methods or processes described above may be performed.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, RAM, ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions marked in the blocks may also occur in an order different from that marked in the accompanying drawings. For example, two successive blocks may in fact be executed substantially concurrently, and sometimes they may also be executed in a reverse order, depending on the functions involved. It should be further noted that each block in the block diagrams and/or flow charts as well as a combination of blocks in the block diagrams and/or flow charts may be implemented using a special-purpose hardware-based system that executes specified functions or actions, or using a combination of special-purpose hardware and computer instructions.

Various embodiments of the present disclosure have been described above. The foregoing description is illustrative rather than exhaustive, and is not limited to the various embodiments disclosed. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the various embodiments disclosed herein.

What is claimed is:

1. A method for a question answering system, comprising:
determining, based on a question input by a user to the question answering system, a root node associated with the question in a decision tree of the question answering system that is used for generating an answer to the question;
determining, based on the root node, a plurality of candidate child nodes among a plurality of child nodes of the root node, wherein a plurality of similarities between the plurality of candidate child nodes and the question are greater than a threshold;
determining, based on a plurality of similarities of a plurality of candidate paths between the root node and the plurality of candidate child nodes, a target path among the plurality of candidate paths;
generating an answer to the question based on the target path; and
determining, based on a reply of the user to the answer, a label for the reply from the user, wherein the label comprises a classification of the question and a degree of satisfaction with the answer.

2. The method according to claim 1, wherein determining, based on the question input by the user to the question answering system, the root node associated with the question comprises performing the following by using a trained natural language model:
extracting a plurality of keywords of the question; and
converting the plurality of keywords into a question feature vector, wherein the question feature vector represents semantics and syntax of the question; and
determining, based on the question feature vector, the root node among a plurality of root nodes of the decision tree.

3. The method according to claim 2, wherein determining, based on the root node, the plurality of candidate child nodes among the plurality of child nodes of the root node comprises:
determining a plurality of child node feature vectors of the plurality of child nodes;
determining the plurality of similarities based on the question feature vector and the plurality of child node feature vectors; and
determining the plurality of candidate child nodes based on the plurality of similarities.

4. The method according to claim 1, wherein determining, based on the plurality of similarities of the plurality of candidate paths between the root node and the plurality of candidate child nodes, the target path among the plurality of candidate paths comprises:
for each candidate path of the plurality of candidate paths:
determining a plurality of similarities between adjacent nodes in each candidate path;
determining a total similarity of each candidate path based on a sum of the plurality of similarities between the adjacent nodes; and
determining a candidate path with the highest total similarity as the target path.

5. The method according to claim 1, wherein generating the answer to the question based on the target path comprises:
generating the answer based on a plurality of child node feature vectors of a plurality of child nodes on the target path and a root node feature vector of the root node, wherein the answer comprises an answer to the question or a further question to the question.

6. The method according to claim 1, wherein determining, based on the reply of the user to the answer, a label for the reply from the user, wherein the label comprises the classification of the question and the degree of satisfaction with the answer comprises:
acquiring the reply of the user to the answer;
determining, based on the reply, a reply feature vector of the reply; and
determining, based on the reply feature vector, the label for the reply from the user.

7. The method according to claim 6, wherein determining, based on the reply feature vector, a label for the reply from the user comprises:
determining validity of the reply based on the reply feature vector;
determining key information of the reply based on the reply feature vector;
determining a classification of the reply based on the reply feature vector; and
determining a label for the reply from the user based on the validity, the key information, and the classification.

8. The method according to claim 7, further comprising:
determining a dialog state based on the label, the question, the answer, a historical label, a historical question, and a historical answer; and
updating a historical dialog state by using the dialog state.

9. The method according to claim 8, further comprising:
retrieving, based on the dialog state, information associated with the dialog state; and
determining, based on the retrieved information, a structured representation of a current dialog, wherein the structured representation comprises a plurality of entities and a plurality of corresponding concepts; and
storing the structured representation in a memory.

10. The method according to claim 9, further comprising:
updating the dialog state based on the structured representation; and
replying to a next question of the user based on at least one of the dialog state and the structured representation.

11. An electronic device, comprising:
a processor; and
a memory coupled to the processor, wherein the memory has instructions stored therein, and the instructions, when executed by the processor, cause the electronic device to perform actions comprising:
determining, based on a question input by a user to a question answering system, a root node associated with the question in a decision tree of the question answering system that is used for generating an answer to the question;
determining, based on the root node, a plurality of candidate child nodes among a plurality of child nodes of the root node, wherein a plurality of similarities between the plurality of candidate child nodes and the question are greater than a threshold;
determining, based on a plurality of similarities of a plurality of candidate paths between the root node and the plurality of candidate child nodes, a target path among the plurality of candidate paths;
generating an answer to the question based on the target path; and
determining, based on a reply of the user to the answer, a label for the reply from the user, wherein the label comprises a classification of the question and a degree of satisfaction with the answer.

12. The electronic device according to claim 11, wherein determining, based on the question input by the user to the question answering system, the root node associated with the question comprises performing the following actions by using a trained natural language model:
extracting a plurality of keywords of the question; and
converting the plurality of keywords into a question feature vector, wherein the question feature vector represents semantics and syntax of the question; and
determining, based on the question feature vector, the root node among a plurality of root nodes of the decision tree.

13. The electronic device according to claim 12, wherein determining, based on the root node, the plurality of candidate child nodes among the plurality of child nodes of the root node comprises:
determining a plurality of child node feature vectors of the plurality of child nodes;
determining the plurality of similarities based on the question feature vector and the plurality of child node feature vectors; and
determining the plurality of candidate child nodes based on the plurality of similarities.

14. The electronic device according to claim 11, wherein determining, based on the plurality of similarities of the plurality of candidate paths between the root node and the plurality of candidate child nodes, the target path among the plurality of candidate paths comprises:
for each candidate path of the plurality of candidate paths:
determining a plurality of similarities between adjacent nodes in each candidate path;
determining a total similarity of each candidate path based on a sum of the plurality of similarities between the adjacent nodes; and
determining a candidate path with the highest total similarity as the target path.

15. The electronic device according to claim 11, wherein generating the answer to the question based on the target path comprises:
generating the answer based on a plurality of child node feature vectors of a plurality of child nodes on the target path and a root node feature vector of the root node, wherein the answer comprises an answer to the question or a further question to the question.

16. The electronic device according to claim 11, wherein determining, based on the reply of the user to the answer, a label for the reply from the user, wherein the label comprises the classification of the question and the degree of satisfaction with the answer comprises:
acquiring the reply of the user to the answer;
determining, based on the reply, a reply feature vector of the reply; and
determining, based on the reply feature vector, the label for the reply from the user.

17. The electronic device according to claim 16, wherein determining, based on the reply feature vector, a label for the reply from the user comprises:
determining validity of the reply based on the reply feature vector;
determining key information of the reply based on the reply feature vector;
determining a classification of the reply based on the reply feature vector; and
determining a label for the reply from the user based on the validity, the key information, and the classification.

18. The electronic device according to claim 17, wherein the actions further comprise:
determining a dialog state based on the label, the question, the answer, a historical label, a historical question, and a historical answer; and
updating a historical dialog state by using the dialog state.

19. The electronic device according to claim 18, wherein the actions further comprise:
retrieving, based on the dialog state, information associated with the dialog state; and
determining, based on the retrieved information, a structured representation of a current dialog, wherein the structured representation comprises a plurality of entities and a plurality of corresponding concepts;
storing the structured representation in a memory;
updating the dialog state based on the structured representation; and
replying to a next question of the user based on at least one of the dialog state and the structured representation.

20. A computer program product, the computer program product being tangibly stored on a non-transitory computer-readable medium and comprising computer-executable instructions, wherein the computer-executable instructions, when executed by a device, cause the device to perform:
determining, based on a question input by a user to a question answering system, a root node associated with the question in a decision tree of the question answering system that is used for generating an answer to the question;
determining, based on the root node, a plurality of candidate child nodes among a plurality of child nodes of the root node, wherein a plurality of similarities between the plurality of candidate child nodes and the question are greater than a threshold;
determining, based on a plurality of similarities of a plurality of candidate paths between the root node and the plurality of candidate child nodes, a target path among the plurality of candidate paths;
generating an answer to the question based on the target path; and
determining, based on a reply of the user to the answer, a label for the reply from the user, wherein the label comprises a classification of the question and a degree of satisfaction with the answer.
